(19) United States
(12) Patent Application Publication
(10) Pub. No.: US 2026/0278456 A1
(43) Pub. Date: Sep. 17, 2026

(54) WEIGHT SORTING QUANTIZATION ERROR REDUCTION

(71) Applicant: QUALCOMM Incorporated, San Diego, CA (US)

(72) Inventors: Jaeseong YOU, Seoul (KR); Seungjae SHIN, Seoul (KR); Seokjun AN, Goyang-si (KR); Vinnam KIM, Seoul (KR); Hyunjae KIM, Seoul (KR); Eungyo SUH, Seoul (KR); Geunho LEE, Seoul (KR)

(21) Appl. No.: 19/082,140

(22) Filed: Mar. 17, 2025

(51) Int. Cl. G06N 20/00

(52) U.S. Cl. CPC G06N 20/00

(57) ABSTRACT

Systems and techniques are described herein for data processing. For example, a computing device can determine, based on characteristics of weights from a first matrix representation of a set of weights of a machine learning model, sensitivity levels of the weights; adjust an order of the first matrix representation to sort a subset of weights from the set of weights based on the sensitivity levels of the weights; process a portion of the first matrix representation associated with the subset of weights to adjust one or more weights from the subset of weights; and update the first matrix representation with the adjusted one or more weights from the subset of weights.

### FIELD

The present disclosure generally relates to data processing using machine learning models. For example, aspects of the present disclosure relate to systems and techniques for weight sorting quantization error reduction, such as by sorting and processing weights of a machine learning model to reduce quantization errors when quantizing the machine learning model (and weights).

### BACKGROUND

Processors (such as computing processing units (CPUs) and general processing units (GPUs)) execute instructions, process data, and manage computing resources of a computing system or device. Processors generally include processing units to perform various logical, arithmetic, and control operations. Processors can have different architectures which can perform the same or similar operations at different efficiencies (e.g., different speeds and using different amounts of computing resources or power). Adjustments in the operations used to perform tasks can result in improvements in efficiency of the processor by adjusting the operations to operations more efficiently performable using the processor architecture. Similarly, adjustments in the operations performable using the processor can affect accuracy of outputs. For example, operations performed before or after quantization can affect accuracy of outputs because of resolution lost when transitioning values from a floating point representation to an integer based representation.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for data processing is provided. The apparatus includes at least one memory and at least one processor coupled to the at least one memory and configured to: determine, based on characteristics of weights from a first matrix representation of a set of weights of a machine learning model, sensitivity levels of the weights; adjust an order of the first matrix representation to sort a subset of weights from the set of weights based on the sensitivity levels of the weights; process a portion of the first matrix representation associated with the subset of weights to adjust one or more weights from the subset of weights; and update the first matrix representation with the adjusted one or more weights from the subset of weights.

In some aspects, a method for data processing is provided. The method includes: determining, based on characteristics of weights from a first matrix representation of a set of weights of a machine learning model, sensitivity levels of the weights; adjusting an order of the first matrix representation to sort a subset of weights from the set of weights based on the sensitivity levels of the weights; processing a portion of the first matrix representation associated with the subset of weights to adjust one or more weights from the subset of weights; and updating the first matrix representation with the adjusted one or more weights from the subset of weights.

In some aspects, a non-transitory computer-readable medium is provided having stored thereon instructions that, when executed by at least one processor, cause the at least one processor to: determine, based on characteristics of weights from a first matrix representation of a set of weights of a machine learning model, sensitivity levels of the weights; adjust an order of the first matrix representation to sort a subset of weights from the set of weights based on the sensitivity levels of the weights; process a portion of the first matrix representation associated with the subset of weights to adjust one or more weights from the subset of weights; and update the first matrix representation with the adjusted one or more weights from the subset of weights.

In some aspects, an apparatus for data processing is provided. The apparatus includes: means for determining, based on characteristics of weights from a first matrix representation of a set of weights of a machine learning model, sensitivity levels of the weights; means for adjusting an order of the first matrix representation to sort a subset of weights from the set of weights based on the sensitivity levels of the weights; means for processing a portion of the first matrix representation associated with the subset of weights to adjust one or more weights from the subset of weights; and means for updating the first matrix representation with the adjusted one or more weights from the subset of weights.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SoC), in accordance with some aspects of the present disclosure;

FIG. 2 is a block diagram of an example transformer, in accordance with some aspects of the disclosure;

FIG. 3 is a block diagram of an example of sorting weights and tensors of a machine learning model, in accordance with some aspects of the disclosure;

FIG. 4 is a block diagram illustrating an example of applying a rotation matrix as an invertible operation to a subset of weights from a set of weights, in accordance with some aspects of the disclosure;

FIG. 5 is a block diagram illustrating an example of applying a per-channel scaling matrix as an invertible operation to a subset of weights from a set of weights, in accordance with some aspects of the disclosure;

FIG. 6 is a flowchart diagram illustrating an example of a process for data processing; in accordance with some aspects of the disclosure;

FIG. 7 is a block diagram illustrating an example neural network; in accordance with some aspects of the disclosure;

FIG. 8 is a block diagram illustrating an example convolutional neural network; in accordance with some aspects of the disclosure;

FIG. 9 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously mentioned, processors (such as computing processing units (CPUs) and general processing units (GPUs)) execute instructions, process data, and manage computing resources of a computing system or device. Processors generally include processing units to perform various logical, arithmetic, and control operations. Processors can have different architectures, which can perform the same or similar operations at different efficiencies (e.g., different speeds and using different amounts of computing resources or power). Adjusting a processor to perform operations that are more efficiently performable using an architecture of the processor to perform tasks can improve the efficiency of the processor. Similarly, adjustments in the operations performable using the processor can affect accuracy of outputs. For example, operations performed before or after quantization can affect accuracy of outputs from the processor because of resolution that is lost when transitioning values from a floating-point representation to an integer-based representation.

Dot product matrix multiplication (also referred to as standard matrix multiplication or a dot product) is an arithmetic operation for multiplying elements of two or more matrices (e.g., an array or vectors) to generate a third matrix. Dot product matrix multiplication can require both matrices of the two or more matrices to have corresponding dimensions. For instance, dot product matrix multiplication can require the first matrix to have the same number of columns as the second matrix has of rows. In some examples, the results of dot product matrix multiplication of a first matrix having m by n (m×n) dimensions and a second matrix having n by p (n×p) dimensions can result in a third matrix having dimensions n by p (n×p) dimensions.

Dot product matrix multiplication can be used by machine learning model to apply weights to tensors so that the machine learning model can determine relationships between data (e.g., data represented in the tensors) and can identify patterns within data. For example, dot product matrix multiplication can be used in attention mechanisms or layers of transformers to apply weights to query, key, and value tensors. In such an example, a matrix representation of tensors of a machine learning model can be dot product matrix multiplied with a matrix representation of weights of a machine learning model (e.g., weights associated with layers of the machine learning model corresponding to the tensors) to determine activations of the machine learning model.

In modern neural networks, input tensors can contain channel-wise outlier values (e.g., tensors which deviate in characteristics from other values in the same input tensors). For example, outlier channels can be identified based on a difference in magnitude, based on Hessian metrics, or based on a gradient of the corresponding weight. Outlier tensors can cause quantization errors when resolution is lost when transitioning the outlier-containing tensors from a floating point domain to an integer domain (or other domain from quantization).

In some examples of operations to reduce quantization errors, a rotation matrix can be applied to a matrix representation of the tensors to adjust tensor valuers of the matrix representation to be more quantization-friendly (e.g., to adjust the values such that less error occurs during quantization). In such examples, another rotation matrix (e.g., an inverse rotation matrix of the rotation matrix applied to the matrix representation of the tensors) can be applied to a matrix representation of the subsequent weights of the machine learning model to negate the preceding rotation matrix to map the weights into a target range of values.

In additional examples of operations to reduce quantization errors, a per-channel scaling matrix can be applied to a matrix representation of the tensors to adjust tensor values of the matrix representation, which can reduce errors from quantization. For instance, the per-channel scaling matrix can apply scalars to the tensors to adjust tensor values to be more accurately quantized. In some cases, the tensor values can be represented as floating point values. The scalars of the per-channel scaling matrix can be set based on the values of the tensor values to map the tensor values into a target range of values to which the tensor values are to be quantized. For example, when the tensor values are to be quantized to integers (such as an 8-bit integer format INT8), the scalars can be set to map the tensor values to a target range of −128 to 127, 0 to 255, or another range which can be represented using INT8.

In some cases, another per-channel scaling matrix (e.g., an inverse per-channel scaling matrix of the per-channel scaling matrix applied to the matrix representation of the tensors) can be applied to a matrix representation of the weights of the machine learning model to map the weights to a target range of values, negating the preceding scaling matrix.

Invertible operations such as rotation, per-channel scaling, and affine transformation matrices require additional memory to store the values of the rotation matrix, per-channel scaling matrix, etc. The invertible operations also incur extra computational resources in scenarios where the adjustments to the weights cannot be fused into the original model weights. Improvements to the invertible operations can result in reduced memory usage and reduced computational resource usage to perform tasks, improving the efficiency of the computer performing the invertible operations.

Systems, apparatuses, electronic devices, methods (also referred to as processes), and computer-readable media (collectively referred to herein as “systems and techniques”) are described herein data processing. For example, the systems and techniques can perform invertible operations for preparing weights and tensors for quantization to reduce errors in quantization (e.g., to improve accuracy in quantization). The invertible operations can be performed by or using a computing device or component thereof such as a processor or processing unit (e.g., a central processing unit (CPU), a digital signal processor (DSP), a graphics processing unit (GPU), a neural processing unit (NPU), a neural signal processor (NSP), etc.).

In some aspects, the systems and techniques can include receiving two matrix representations. The first matrix representation can represent a matrix of weight values associated with weights of a machine learning model. In some examples, the first matrix representation can be associated with weights of one or more layers of the machine learning model. The second matrix representation can represent a matrix of tensors (e.g., tensor values) associated with input tensors provided as input to the machine learning model. In some examples, the tensors of the second matrix representation can correspond to weights of the first matrix representation. In some aspects, the tensors can correspond to a linear layer of the machine learning model associated with one or more weights from the first matrix representation.

In some aspects, the systems and techniques can include sorting the weights of the first matrix representation based on a sensitivity level of the weights. The sensitivity level of the weights can refer to an amount to which machine learning model outputs are affected by changes in the weights. For example, a change in a first weight may cause a greater change in the outputs of a layer of a machine learning model than an equal change to a second weight. In such an example, the first weight would be more sensitive (e.g., a higher sensitivity level) than the second weight (e.g., a lower sensitivity level). In further examples, the sensitivity levels can be based on tensors associated with the weights. In other examples, the systems and techniques can include a calibration process where a calibration dataset is processed using the machine learning model associated with the weights to determine the sensitivity levels (e.g., determined sensitivity levels).

In some examples, the sensitive weights of the subset of weights can correspond to tensors from the second matrix representation of sensors. The second matrix representation can be represented as matrix X, and the subset of tensors from the set of tensors of the second matrix representation corresponding to the sensitive weights can be represented as Xₛₑₙ∈ [symbol] ^{N×k} wherein Xₛₑₙ represents the subset of tensors corresponding to the sensitive weights (based on sensitivity level) and N×k represents the portion (e.g., rows and columns) of the second matrix representation including Xₛₑₙ. Xₙₒₙ∈ [symbol] ^{N×k} can represent a subset of nonsensitive (based on sensitivity level) tensors (e.g., Xₙₒₙ) of the second matrix representation. Xₚₐᵣₜ=[Xₛₑₙ Xₙₒₙ]∈ [symbol] ^{N×2k} represents a subset of tensors from the second matrix representation including the most sensitive and the least sensitive tensors (based on sensitivity level). X_{remainder}∈ [symbol] ^{N×(D}^{ᵢₙ}^{-2k)} can represent the remaining tensors of the second matrix representation not included in Xₚₐᵣₜ.

In some examples, Wₚₐᵣₜ ∈ [symbol] ^{2k×D}^{ₒᵤₜ} can represent portions of the first matrix representation corresponding to Xₚₐᵣₜ (e.g., Wₚₐᵣₜ can represent the subset of weights from the first matrix representation including the most sensitive and the least sensitive weights). W_{remainder}∈ [symbol] ^{(D}^{ᵢₙ}^{-2k)×D}^{ₒᵤₜ} can represent the remaining weights not included in Wₚₐᵣₜ. The weights of W_{remainder} can correspond to tensors of X_{remainder}.

When the invertible operation is a rotation matrix (as further described below), the rotation matrix can be represented as R∈ [symbol] ^{2k×2k}. In such an example, the quantization of the weights and tensors can be represented as

$$Q ( [ \begin{matrix}{X}_{part} R & {X}_{remainder}\end{matrix} ] ) * Q ( [ \begin{matrix}{R}^{- 1} {W}_{part} \\ {W}_{remainder}\end{matrix} ] )$$

where Q represents a quantizer (e.g., quantization function) to quantize portions of the first matrix representation and the second matrix representation. In some examples, portions of the first matrix representation and portions of the second matrix representation can be quantized separately. In further examples, the first matrix representation and the second matrix representation can be rearranged to adjust the position of Xₚₐᵣₜ within the second matrix representation and Wₚₐᵣₜ within the first matrix representation, for example by appending Xₚₐᵣₜ to an end of the second matrix representation and appending Wₚₐᵣₜ to an end of the first matrix representation.

The sensitivity level of the weights can be determined based on characteristics of the weights. For example, the characteristics of the weights can include magnitude of the weights (e.g. weight value magnitude). In another example, the characteristics can include Hessian metrics of the weights. Hessian metrics can include applying second-order optimization algorithms such as Newton-Raphson method to determine Hessian values of the weights to generate a Hessian matrix. The Hessian matrix can be a square matrix of second-order partial derivatives indicating how a loss function changes with changes in the weights. Another example characteristic can include a gradient of the weights (e.g., a change in weights of the matrix representation). The gradients can be determined by performing a forward-pass of data and backpropagate. A sensitive weight is more likely to be exposed to a larger amount of change, which would correspond to the norm of the gradient to that weight.

In some aspects, the systems and techniques can include sorting weights (or groups of weights) from the first matrix representation based on the characteristics of the weights. The systems and techniques can include adjusting the order of the weights within the first matrix representation based on the sensitivity levels. Adjustments to the order of the weights can include rearranging columns, rows, or portions of the rows and columns within the first matrix representation. In such an example, tensors of the second matrix representation can be rearranged based on adjustments to the first matrix representation. For example, tensors of the second matrix representation can correspond to weights of the first matrix representation. In such an example, rearrangement of corresponding weights can include rearrangement of corresponding tensors of the second matrix representation.

In some examples, the adjustments can include rearranging the first matrix representation to pair weights from the set of weights into a subset of weights including one more of the least sensitive weights and one or more of the most sensitive weights (based on sensitivity levels). The most sensitive weights and the least sensitive weights can be referred to as outlier weights. The systems and techniques can include performing invertible operations on the subset of weights and tensors corresponding to the subset of weights. The results of the invertible operations can be appended to the first matrix representation (e.g., results of invertible operations on the subset of weights) and appended to the second matrix representation (e.g., results of invertible operations on the tensors corresponding to the subset of weights).

The invertible operations can include applying a rotation matrix to the subset of weights. For example, the rotation matrix can be a square matrix representing a rotation transformation. The rotation matrix can be an orthogonal matrix with a determinant of 1 to preserve orientation of the matrix to which the rotation matrix is applied (e.g., matrix multiplied). In some examples, the rotation matrix applied to the subset of weights can be an inverse rotation matrix of a rotation matrix applied to the tensors corresponding to the set of weights. The size of the rotation matrix can be based on the dimensions of the subset of weights. For example, the rotation matrix can be a 2×2 matrix when the dimensions of the subset of weights is 3×2. In another example, the rotation matrix can be a 3×3 matrix when the dimensions of the subset of weights is 4×3, etc. The rotation matrix shape (e.g., dimensions) can be set based on a size necessary to perform matrix dot product matrix multiplication (e.g., standard matrix multiplication) of the subset of weights.

In some examples, the rotation matrix can be a Hadamard rotation matrix, a learned rotation matrix, a Kronecker-decomposed matrix, or another invertible matrix to perform a whitening projection (e.g., an invertible matrix which can decorrelate weights or tensors to which the invertible matrix is applied).

For example, a Hadamard rotation matrix can be an orthogonal matrix derived from a Hadamard transform. For example, a Hadamard matrix of an order of 2n can be represented as

$${H}_{2} = [ \begin{matrix}H & H \\ H & - H\end{matrix} ]$$

for a 2×2 matrix. In some examples, the Hadamard matrix can be scaled. The learned rotation matrix can be a rotation matrix determined during training of the machine learning model. For example, the learned rotation matrix can be updated using various learning techniques such as gradient-based learning to determine a rotation matrix (e.g., a matrix which is invertible) which can be applied to the subset of weights to reduce quantization error. The Kronecker-decomposed matrix can include a matrix expressed as a Kronecker product of two or more matrices. For example, the Kronecker-decomposed matrix can be multiple smaller matrices which can be applied to the subset of weights to reduce quantization error during quantization. In such an example, by applying the rotation matrix to the subset of weights (e.g., the subset including the most sensitive and the least sensitive weights by sensitivity level), the computing device can conserve computational resources by determining dot product matrix multiplication of a reduced rotation matrix and the subset of weights, as opposed to determining dot product matrix multiplication of a larger rotation matrix and the entire first matrix representation.

In some aspects, the invertible operations can include applying a per-channel scaling matrix to the subset of weights. In some examples, the per-channel scaling matrix applied to the subset of weights can be an inverted matrix of a per-channel scaling matrix applied to tensors from the second matrix representation corresponding to the subset of weights. In such an example, the per-channel scaling matrix can be a diagonal matrix including scalars used to scale individual channels of the first matrix representation and the second matrix representation. For example, the per-channel scaling matrix can be represented as

$$S = [ \begin{matrix}{s}_{1} & 0 & 0 \\ 0 & {s}_{2} & 0 \\ 0 & 0 & {s}_{3}\end{matrix} ]$$

where s₁, s₂, and s₃ are scalars. The size of the per-channel scaling matrix can be adjusted based on the size of the portion of the first matrix representation and the second matrix representation with which to be dot product matrix multiplied (also referred to as standard matrix multiplication or matrix multiplication (MatMul)).

In some aspects, the per-channel scaling matrix can include one or more of a derived per-channel scaling matrix, a searched per-channel scaling matrix, or a learned per-channel scaling matrix. For example, a derived per-channel scaling matrix be determined as a pre-processing operation for quantizing the weights and tensors, such as using SmoothQuant to derive a per-channel scaling matrix. In another example, the searched per-channel scaling matrix can be a per-channel scaling matrix where scalars of the per-channel scaling matrix are determined using a search process, such as hyperparameter optimization of the machine learning model, grid search, random search, or Bayesian optimization, to determine scalars from a search space of possible scalar values. The learned per-channel scaling matrix can refer to a per-channel scaling matrix where the scalars are optimized during a learning process, such as optimized during backpropagation to fine-tune the scalars.

In some aspects, the results of the invertible operation (e.g., applying a rotation matrix and an inverse rotation matrix, or applying a per-channel scaling matrix and an inverse per-channel scaling matrix) performed with a portion of the first matrix representation and a corresponding portion of the second matrix representation can be used to update or adjust the corresponding matrix representation. For example, the first matrix representation can be updated to include the results of the invertible operation applied to the subset of weights and the second matrix representation can be updated to include the results of invertible operation to the tensors corresponding to the subset of weights.

In some aspects, the systems and techniques can include quantizing the updated first matrix representation and quantizing the updated second matrix representation to generate a first quantized matrix representation associated with the weights of the machine learning model and a second quantized matrix representation associated with a set of tensors corresponding to the weights of the first quantized matrix representation. The first quantized matrix representation and the second quantized matrix representation can be processed to generate a third matrix representation representing a set of output activations (also referred to as a set of activations) of the machine learning model.

Various aspects of the present disclosure will be described with respect to the figures.

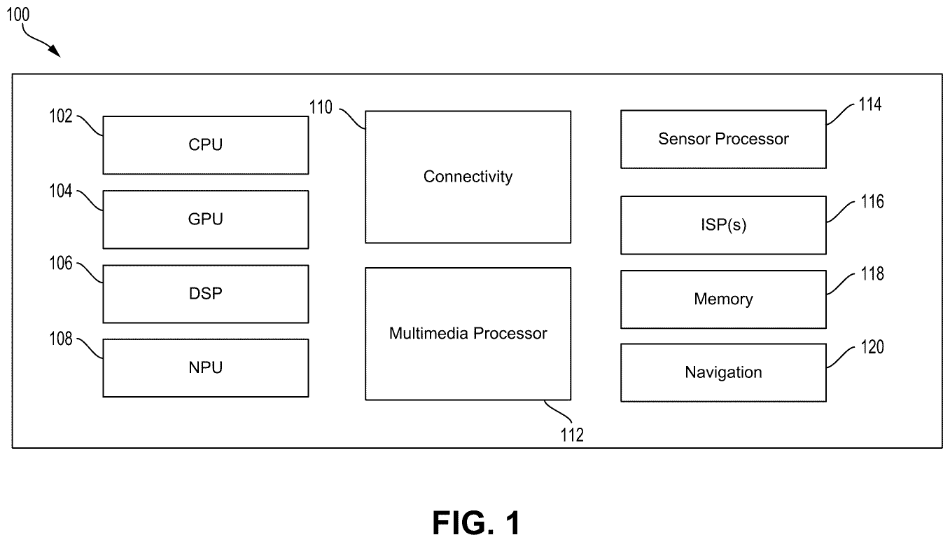

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 110, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured generate explanations for actions performed (e.g., to be performed, predicted to be performed, etc.) by a machine learning model. The explanations can be one or more of a text-based description, set of instructions to perform a sub-task or task, etc. according to aspects of the present disclosure discussed herein. The SOC can be used to operate various machine learning models for image processing, text processing, feature extraction, signal controls generation, etc. For example, SOC 100 and/or components thereof may be configured to perform processing techniques such as but not limited to: segment shifting, shuffle correlation, gain shifting, segment masking, and additional processing techniques. SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of audio can benefit from first learning to recognize individual spoken words, instruments in music, etc. These features may be combined at higher layers in different ways to recognize sounds such as speech, instruments, wind noise, etc.

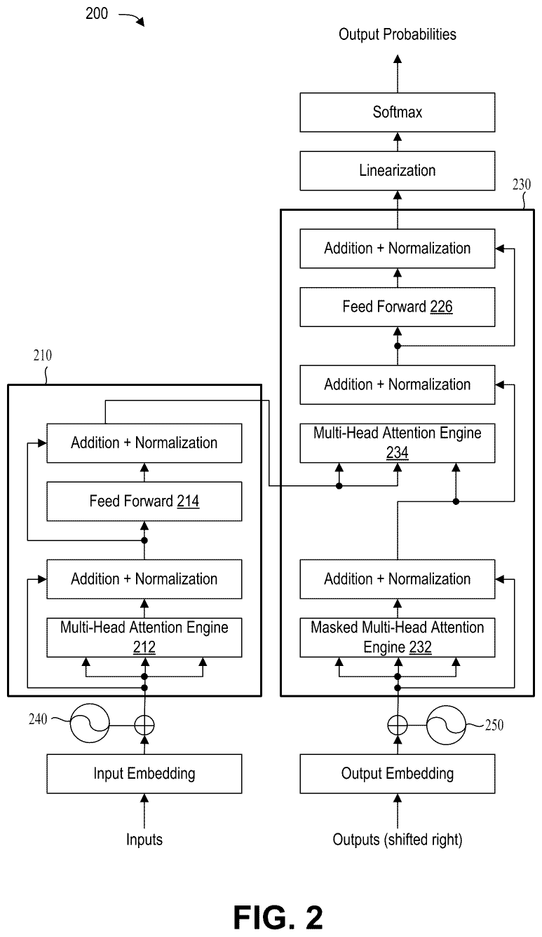

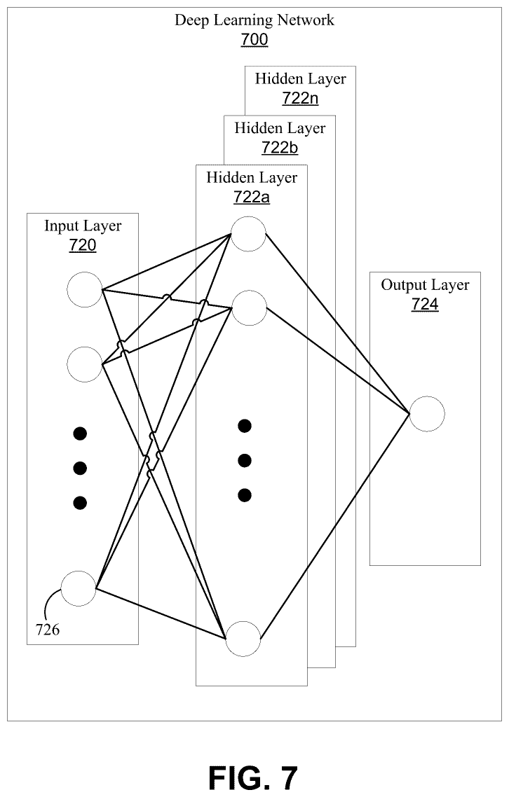

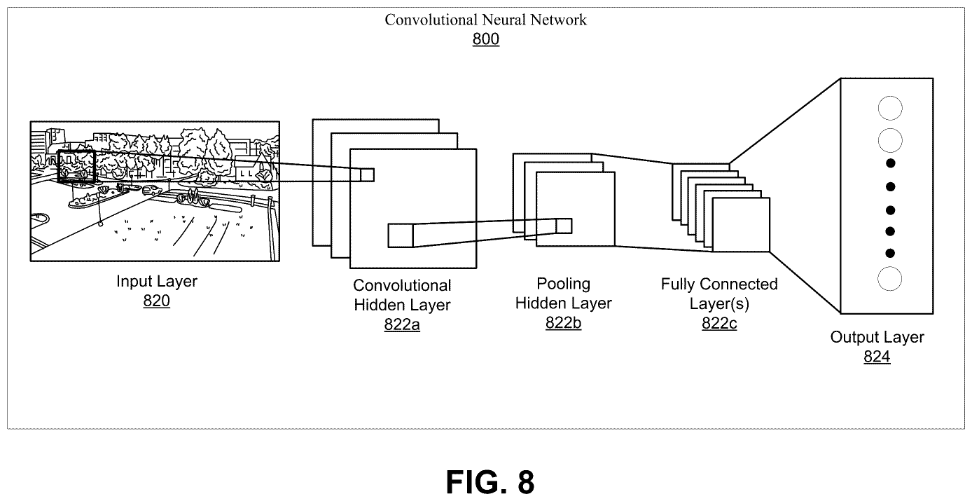

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. Further description of machine learning model architecture is provided in the description of FIG. 2, FIG. 7, and FIG. 8.

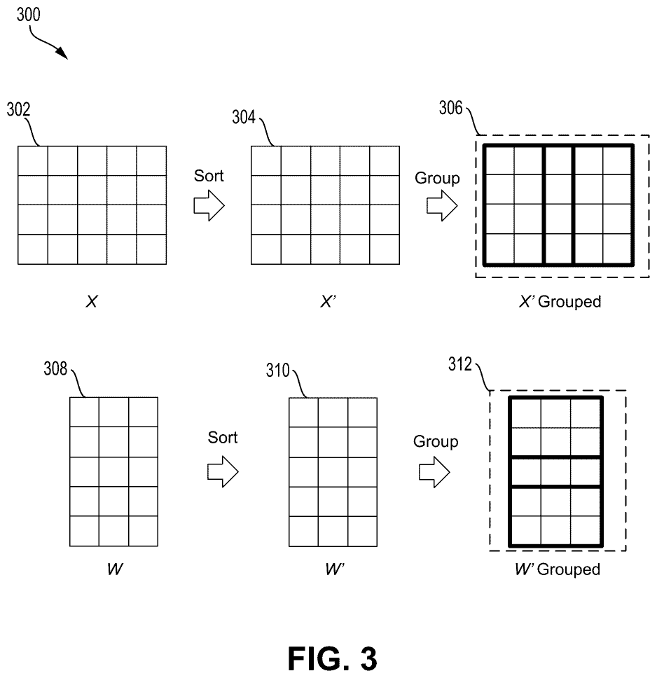

The SOC 100 of FIG. 1 can be used to perform the various systems and techniques described in the descriptions of FIG. 2-FIG. 8. For example, the SOC 100 can be used to perform operations of the transformer 200 of FIG. 2, the neural network 700 of FIG. 7, the convolutional neural network 800 of FIG. 8. The SOC 100 can perform invertible operations (e.g., applying a rotation matrix or per-channel scaling matrix as further described in the descriptions of FIGS. 3-5) and quantize weights and tensors of a machine learning model using the CPU 102, DSP 106, and/or GPU 104.

FIG. 2 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 200 reduces the operations of learning dependencies by using an encoder 210 and a decoder 230 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 210 is composed of a stack of six identical layers and each layer has two sub-layers. The first sub-layer is a multi-head self-attention engine 212, and the second sub-layer is a fully connected feed-forward network 214. A residual connection (not shown) connects around each of the sub-layers followed by normalization.

In this example transformer 200, the decoder 230 is also composed of a stack of six 6 identical layers. The decoder also includes a masked multi-head self-attention engine 232, a multi-head attention engine 234 over the output of the encoder 210, and a fully connected feed-forward network 226. Each layer includes a residual connection (not shown) around the layer, which is followed by layer normalization. The masked multi-head self-attention engine 232 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 240 to encode positions because the model does not contain recurrence and convolution and relative or absolute position of the tokens can be needed. In the transformer 200, the positional encodings are added to the input embeddings at the bottom layer of the encoder 210 and the decoder 230. The positional encodings can be summed with the embeddings because the positional encodings and embeddings have the same dimensions. A corresponding position decoder 250 is configured to decode the positions of the embeddings for the decoder 230.

In some aspects, the transformer 200 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 200 can process input sequences of variable length, making it well-suited for natural language processing tasks where input lengths can vary greatly. Additionally, the self-attention mechanism allows the transformer 200 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 3 is a block diagram 300 illustrating an example of sorting and grouping of tensors (e.g., input tensors) and weights of a machine learning model into subsets. For example, the block diagram 300 includes a tensor set 302 representing a set of tensors associated with one or more layers of the machine learning model. The block diagram 300 includes a weight set 308 representing a set of weights associated with the one or more layers of the machine learning model and corresponding to the tensor set 302. The tensor set 302 and the weight set 308 can be represented as matrices (e.g., matrix representations) with each element of the matrices representing a tensor or weight.

The block diagram 300 illustrates sorting of the tensor set 302 and the weight set 308. For example, the tensor set 302 and the weight set 308 can be sorted based on sensitivity levels of the weights. In further examples, the sensitivity levels can be based on the characteristics of the weights, the tensors, or both. In further examples, the sensitivity levels can be based on portions of the weight set 308 and portions of the tensor set 302. For example, the sensitivity levels can be based on a row or column of the weight set 308 and the tensor set 302.

The sensitivity level can refer to an amount to which machine learning model outputs are affected by changes in the weights. In some examples, the sensitivity levels can be represented as discrete sensitivity levels (e.g., sensitivity level 1, sensitivity level 2, etc.). In other examples, the sensitivity levels can be represented as a sensitivity value associated with characteristics of the weights. In one example, the sensitivity level can be determined based on a calibration process of the machine learning model (or portion of the machine learning model associated with the weight set 308).

In such an example, a calibration data set can be processed using the machine learning model. Weights from the weight set 308 can be adjusted and changes in outputs of a layer of the machine learning model can be measured to determine effects of the changes in the weights. In such an example, weights causing a greater amount of change in the outputs (such as measured in magnitude of the outputs) when adjusted can be determined as being more sensitive (e.g., having a higher sensitivity and higher sensitivity level). Weights, which when adjusted, causing a lower amount of change in the outputs can be determined as being less sensitive (e.g., having a lower sensitivity and lower sensitivity level. In some examples, sensitivity levels can be determined for individual weights. In other examples, sensitivity levels can be determined for groups of weights from the weight set 308. In such an example, a sensitivity level can be determined for a row of weights or a column of weights from the weight set 308.

In some examples, the sensitivity level of weights can be based on characteristics of the weights. For example, the characteristics can include a magnitude of the weights. In such an example, the magnitude of weights (e.g., weight values) can be used to determine the sensitivity level. In such an example, larger weights can be determined to be more sensitive to adjustments and correspond to a higher sensitivity level.

In another example, the characteristics can include Hessian metrics of the weights. Hessian metrics can include applying second-order optimization algorithms to determine Hessian values of the weights. In such an example, the characteristics can be represented as a Hessian matrix of the second-order partial derivatives. The second-order partial derivatives can indicate changes in a loss function changes based on changes in the weights from the weight set 308. Another example characteristic can include a gradient of the weights (e.g., a change in weights of the weight set 308).

The block diagram 300 illustrates sorting of the tensor set 302 and the weight set 308 to generate a sorted tensor set 304 and a sorted weight set 310. For example, the weights set 308 and the tensor set 302 can be sorted based on sensitivity level (or characteristics associated with the sensitivity level) of the weights or tensors. For example, the weight set 308 and the tensor set 302 can be rearranged based on the sensitivity level of portions of the weight set 308 or the tensor set 302. In some examples, the weight set 308 and the tensor set 302 are rearranged in a corresponding manner, such that tensors corresponding to weights rearranged based on sensitivity levels are rearranged accordingly (e.g., when a first tensor corresponds a first weight, rearrangement of the first weight can include rearrangement of the first tensor, or vice versa).

For example, adjustments to the order of weights of the weight set 308 can include rearranging columns, rows, or portions of the rows and columns of the weight set 308 (e.g., of a matrix representation of the weight set). In such an example, tensors of the tensor set 302 can be rearranged based on adjustments to the weight set 308. Weights and tensors from the sorted tensor set 304 and the sorted weight set 310 can be grouped into subsets of weights 312 from the sorted weight set 310 and subsets of tensors 306 from the sorted tensor set 304 based on sensitivity levels of the weights. In one example, the subset of weights 312 can include one more of the least sensitive weights and one or more of the most sensitive weights (based on sensitivity levels).

In such an example, the most sensitive weights and the least sensitive weights can be referred to as outlier weights. The outlier weights can be used to perform invertible operations, such as by applying a rotation matrix or per-channel scaling matrix to the outlier weights to adjust the outlier weights. The adjusted weights can then be appended to the sorted weight set 310 to replace the outlier weights.

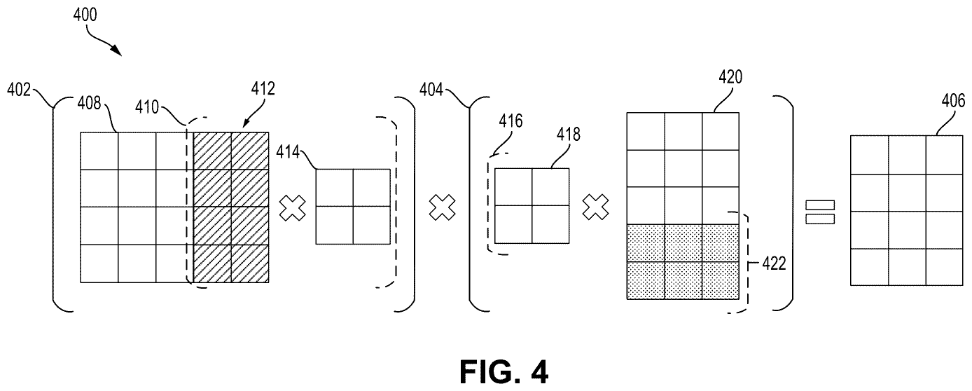

FIG. 4 is a block diagram 400 illustrating an example of applying a rotation matrix 418 as an invertible operation to a subset of weights 422 from a set of weights 420. The block diagram 400 illustrates quantization and matrix multiplication of a set of weights 420 and a set of tensors 408 to generate a set of output activations 406. The set of weights 420 can be represented as a first matrix representation with elements of the first matrix representation being weights (weight values) from the set of weights 420. In such an example, the set of tensors 408 can be represented as a second matrix representation with elements of the second matrix representation being tensors (e.g., input tensors or input tensor values) from the set of tensors 408. The weights of the set of weights 420 can correspond to layers of a machine learning model. The tensors of the set of tensors 408 can be input tensors to the layers of the machine learning model, and can correspond to weights of the set of weights 420.

The block diagram 400 illustrates multiple different operations. For example, the block diagram 400 includes operation 410 representing dot product matrix multiplication of the subset of tensors 412 and a rotation matrix 414, and a first quantization operation 402 representing quantization of the set of tensors 408 including the results of the operation 410. The block diagram 400 illustrates operation 416 representing dot product matrix multiplication of the subset of weights 422 and a rotation matrix 418. The results of the operation 416 can be included in the set of weights 420. The block diagram 400 further includes a second quantization operation 404 representing the quantization of the set of weights 420 including the results of operation 416. The results of the first quantization operation 402 and the results of the second quantization operation 404 can be dot product matrix multiplied to generate the set of output activations 406 (also referred to as a set of activations). Further description of the various operations is provided below.

The set of tensors 408 and the set of weights 420 can be in a floating point domain. FIG. 4 illustrates quantization of the set of weights 420 and the set of tensors 408 using an invertible operation to conserve computational resource usage and memory usage. For example, the set of weights 420 can be the sorted weight set 310 from FIG. 3. The set of weights 420 can be sorted based on sensitivity levels of the weights. In such an example, the subset of weights 422 can include one or more weights determined to be least sensitive (e.g., the lowest sensitivity level) and one or more weights determined to be most sensitive (e.g., the highest sensitivity level).

The block diagram 400 illustrates performing dot product matrix multiplication of the subset of weights 422 and the rotation matrix 418. The rotation matrix 418 can be a square matrix representing a rotation transformation. In such an example, the rotation matrix 418 can be invertible. For example, rotation matrix 414 and rotation matrix 418 can be inverse rotation matrices of the other. The rotation matrix can include a determinant of 1 to preserve orientation of the subset of weights 422 when applied (e.g., dot product matrix multiplied) with the subset of weights 422.

The size of the rotation matrix 418 can be based on the dimensions of the subset of weights 422 to allow for dot product matrix multiplication of the rotation matrix 418 and the subset of weights 422, as represented in the operation 416. The operation 416 represents dot product matrix multiplication of the rotation matrix 418 and the subset of weights 422. The results of the operation 410 can be included in the set of weights 420 to replace the subset of weights 422. For example, the operation 416 can adjust one or more weights of the subset of weights 422. In such an example, the set of weights 420 can be updated to include the adjusted one or more weights of the subset of weights 422. The block diagram 400 illustrates the rotation matrix 418 as being a 2×2 matrix and the subset of weights 422 as being a 2×3 matrix. In an example where the subset of weights 422 is of different dimensions, such as a 3×2 matrix, the rotation matrix 418 can be a 3×3 matrix.

The rotation matrix 414 can be an inverse of the rotation matrix 418 (and vice versa). The rotation matrix can be applied (e.g., using dot product matrix multiplication) to adjust tensor values of the subset of tensors 412, as represented by the operation 410. The set of tensors 408 can be updated to include the results of operation 410. The block diagram 400 illustrates the rotation matrix 414 as being a 2×2 matrix and the subset of weights 422 as being a 2×4 matrix. In an example where the subset of tensors 412 is of different dimensions, such as a 4×2 matrix, the rotation matrix 414 can be a 4×4 matrix.

The set of tensors 408 including the results of operation 410 and the set of weights 420 including the results of operation 416 can be quantized using the first quantization operation 402 (for the set of tensors 408) and the second quantization operation 404 (for the set of weights 420) to generate a quantized representation of the set of tensors and a quantized representation of the set of weights. The quantized representation of the set of tensors and the quantized representation of the set of weights can be processed (e.g., apply dot product matrix multiplication) to generate the set of output activations 406.

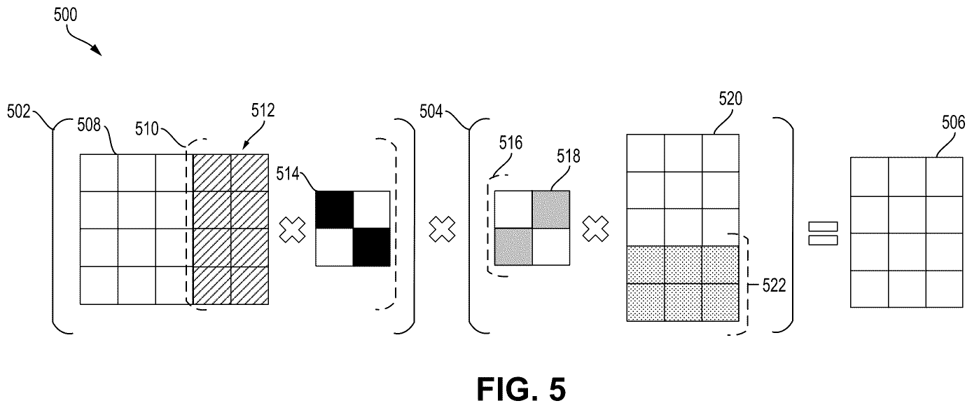

FIG. 5 is a block diagram 500 illustrating an example of applying a per-channel scaling matrix 518 as an invertible operation to a subset of weights 522 from a set of weights 520. The block diagram 500 illustrates quantization and dot product matrix multiplication of a set of weights 520 and a set of tensors 508 to generate a set of output activations 506 (also referred to as a set of activations). The set of weights 520 can be represented as a first matrix representation with elements of the first matrix representation being weights from the set of weights 520. In such an example, the set of tensors 508 can be represented as a second matrix representation with elements of the second matrix representation being tensors from the set of tensors 508. In some examples, the weights of the set of weights 520 can correspond to layers of a machine learning model.

The block diagram 500 illustrates multiple different operations. For example, the block diagram 500 includes operation 510 representing dot product matrix multiplication of the subset of tensors 512 and a per-channel scaling matrix 514. The block diagram 500 further includes a first quantization operation 502 representing quantization of the set of tensors 508 including the results of the operation 510. The block diagram 500 illustrates operation 516 representing dot product matrix multiplication of the subset of weights 522 and a per-channel scaling matrix 518. The results of the operation 516 can be included in the set of weights 520. For example, the results of the operation 516 can replace the subset of weights 522.

The block diagram 500 further includes a second quantization operation 504 representing the quantization of the set of weights 520 including the results of operation 516. The results of the first quantization operation 502 and the results of the second quantization operation 504 can be dot product matrix multiplied to generate the set of output activations 506. Further description of the various operations is provided below.

The set of tensors 508 and the set of weights 520 can be in a floating point domain. Quantization operations (e.g., the first quantization operation 502 and the second quantization operation 504) can be used to transform the set of tensors 508 (including the results of the operation 510) and the set of weights 520 (including the results of the operation 516) into an integer domain, such as INT8. FIG. 5 illustrates quantization of the set of weights 520 and the set of tensors 508 using an invertible operation (e.g., applying a per-channel scaling matrix) to a portion of the set of tensors 508 (e.g., the subset of tensors 512) and a portion (e.g., the subset of weights 522) of the set of weights 520 to conserve computational resource usage and memory usage. For example, computational resource usage and memory usage can be reduced at least because the set of weights 520 in entirety is not processed, rather the subset of weights 522 can be processed.

The set of weights 520 can be sorted based on sensitivity levels of the weights. In such an example, the subset of weights 522 can include one or more weights determined to be having the lowest sensitivity level and one or more weights determined having the highest sensitivity level (as further described in the description of FIG. 3). The block diagram 500 illustrates performing dot product matrix multiplication of the subset of weights 522 and the per-channel scaling matrix 518. For example, the per-channel scaling matrix 518 can be an inverted matrix of the per-channel scaling matrix 514 (or vice versa). In such an example, the per-channel scaling matrix can be a diagonal matrix. Elements of the per-channel scaling matrix can include scalars. The scalars can be used to scale individual channels of the subset of weights 522. For example, the scalars can be used to adjust one or more weights of the subset of weights 522. In such an example, the adjusted one or more weights of the subset of weights 522 can be used to update (e.g., replace) the one or more weights from the subset of weights 522. The size of the per-channel scaling matrix can be adjusted based on the size of the portion of the subset of weights 522.

The set of tensors 508 (including the results of operation 510) and the set of weights 520 (including the results of operation 516) can be quantized using the first quantization operation 502 (for the set of tensors 508) and the second quantization operation 504 (for the set of weights 520) to generate a quantized representation of the set of tensors and a quantized representation of the set of weights. For example, the first quantization operation 502 and the second quantization operation 504 can transform the set of tensors 508 and the set of weights 520 from a floating point domain to an integer domain. The quantized representations can be processed (e.g., by performing a dot product matrix multiplication) to determine the set of output activations 506. In such an example, the output activations 506 can be in the same domain as the quantized representations (e.g., an integer domain such as INT8).

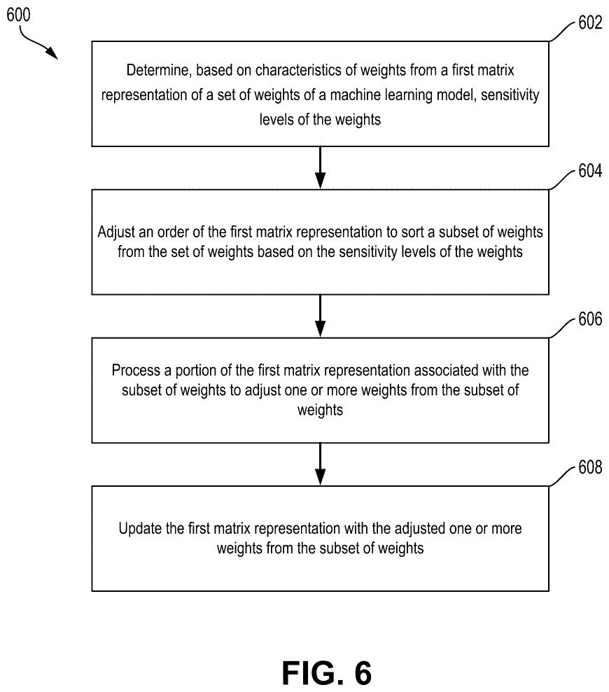

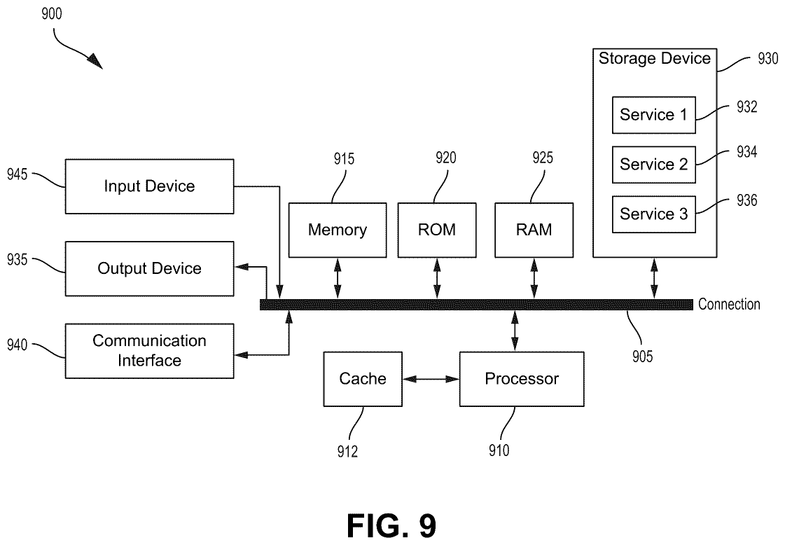

FIG. 6 is a flow diagram illustrating an example process 600 for data processing. In particular, the process 600 illustrates an example process data processing, performed using a processor (e.g., the CPU 102 of FIG. 1 or the processor 910 of FIG. 9). Computing cores of the processor can be used to perform the process 600 of data processing to perform dot product matrix multiplication. The processor can be used to perform operations of a machine learning model (e.g., to perform weight scaling, quantization, linear transformations, etc.), such as the transformer 200 of FIG. 3, the neural network 700 of FIG. 7, the convolutional neural network of FIG. 8, an LLM, etc. The process 600 can be performed by a computing device (e.g., the computing device or computing system 900 of FIG. 9, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 600 can be implemented as software components that are executed and run on one or more processors (e.g., CPU 102 of FIG. 1, the processor 910 of FIG. 9, or other processor(s)) of the computing device. Further, the transmission and reception of signals by the computing device in the process 600 can be enabled, for example, by one or more antennas and/or one or more transceivers (e.g., wireless transceiver(s)).

At block 602, the computing device (or component thereof) can determine sensitivity levels of the weights. In some examples, the sensitivity level can be based on characteristics of weights from a first matrix representation of a set of weights of a machine learning model. In some examples, the characteristics of the weights can include a magnitude of the weights, Hessian metrics of the first matrix representation, and a gradient of the weights. Hessian metrics can include applying second-order optimization algorithms such as Newton-Raphson method to determine Hessian values of the weights to generate a Hessian matrix. In another example characteristic, the characteristics can include a gradient of the weights (e.g., a change in magnitude of the weights).

At block 604, the computing device (or component thereof) can adjust an order of the first matrix representation to sort a subset of weights from the set of weights based on the sensitivity levels of the weights. In another example, the subset of weights can include one or more weights associated with a highest sensitivity level of determined sensitivity levels and one or more weights associated with a lowest sensitivity level of the determined sensitivity levels. For example, the subset of weights can include weights associated with the highest sensitivity level and the subset of weights can include weights associated with the lowest sensitivity level.

At block 606, the computing device (or component thereof) can process a portion of the first matrix representation associated with the subset of weights to adjust one or more weights from the subset of weights. In some examples, processing the portion of the first matrix representation to adjust the one or more weights from the subset of weights can include processing the portion of the first matrix representation by performing a dot product of the subset of weights and a rotation matrix (e.g., the rotation matrix 414 and the rotation matrix 418 of FIG. 4). The rotation matrix can be a square matrix representing a rotation transformation. For example, the rotation matrix can be an orthogonal matrix with a determinant of 1 to preserve orientation of the matrix to which the rotation matrix is applied. In further examples, the rotation matrix applied to the subset of weights can be an inverse rotation matrix of a rotation matrix. In such an example, the inverse rotation matrix can be applied to tensors corresponding to the set of weights or corresponding to the subset of weights. The rotation matrix can be set based on the dimensions of the subset of weights (e.g., set to dimensions allowing dot product multiplication between the subset of weights and the rotation matrix).

In further examples, the rotation matrix can be a Hadamard rotation matrix, a learned rotation matrix, or a Kronecker-decomposed matrix. In further examples, processing the portion of the first matrix representation to adjust the one or more weights from the subset of weights can include processing the portion of the first matrix representation by performing a dot product of the subset of weights and a per-channel scaling matrix (e.g., the per-channel scaling matrix 514 and the per-channel scaling matrix 518 of FIG. 5). In further examples, the per-channel scaling matrix can includes at least one of a derived per-channel scaling matrix, a searched per-channel scaling matrix, or a learned per-channel scaling matrix.

At block 608, the computing device (or component thereof) can update the first matrix representation with the adjusted one or more weights from the subset of weights. For example, the computing device (or component thereof) can update the subset of weights with the adjusted one or more weights and maintain the weights of the set of weights outside of the subset of weights. In further examples, the computing device (or component thereof) can quantize the updated first matrix representation to generate a first quantized matrix representation of the set of weights. In some examples, the computing device (or component thereof) can process the first quantized matrix representation and a second quantized matrix representation of a set of tensors corresponding to the machine learning model to generate a second matrix representation of a set of activations of the machine learning model. In some examples, the set of tensors of the second quantized matrix representation can correspond to a linear layer of the machine learning model associated with one or more weights from the set of weights.

FIG. 7 is an illustrative example of a deep learning neural network 700 that can be used by the SOC 100. An input layer 720 includes input data. In one illustrative example, the input layer 720 can include data representing the pixels of an input image or video frame. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network 700 further includes an output layer 724 that provides an output resulting from the processing performed by the hidden layers 722a, 722b, through 722n. In one illustrative example, the output layer 724 can provide a classification for an object in an input image or video frame. The classification can include a class identifying the type of object (e.g., a static object, a vehicle, a person, a dog, a cat, or other object).

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the hidden layers 722a, 722b, through 722n can transform the information of each input node by applying activation functions to the information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 724, at which an output is provided. In some cases, while nodes (e.g., node 726) in the neural network 700 are shown as having multiple output lines, a node has a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 724. In an example in which the neural network 700 is used to identify objects in images, the neural network 700 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 700 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 700 is trained well enough so that the weights of the layers are accurately tuned.

For the example of identifying objects in images, the forward pass can include passing a training image through the neural network 700. The weights are initially randomized before the neural network 700 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 700, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 700 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 700 can perform a backward pass by determining which inputs (weights) most contributed to the loss of the network and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 700 can include any suitable deep network. One example includes a convolutional neural network (CNN), which includes an input layer and an output layer, with multiple hidden layers between the input and out layers. An example of a CNN is described below with respect to FIG. 7. The hidden layers of a CNN include a series of convolutional, nonlinear, pooling (for downsampling), and fully connected layers. The neural network 700 can include any other deep network other than a CNN, such as an autoencoder, a deep belief nets (DBNs), a Recurrent Neural Networks (RNNs), among others.

FIG. 8 is an illustrative example of a convolutional neural network 800 (CNN 800). The input layer 820 of the CNN 800 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 822a, an optional non-linear activation layer, a pooling hidden layer 822b, and fully connected hidden layers 822c to get an output at the output layer 824. While only one of each hidden layer is shown in FIG. 8, one of ordinary skill will appreciate that multiple convolutional hidden layers, non-linear layers, pooling hidden layers, and/or fully connected layers can be included in the CNN 800. As previously described, the output can indicate a single class of an object or can include a probability of classes that best describe the object in the image.

The first layer of the CNN 800 is the convolutional hidden layer 822a. The convolutional hidden layer 822a analyzes the image data of the input layer 820. Each node of the convolutional hidden layer 822a is connected to a region of nodes (pixels) of the input image called a receptive field. The convolutional hidden layer 822a can be considered as one or more filters (each filter corresponding to a different activation or feature map), with each convolutional iteration of a filter being a node or neuron of the convolutional hidden layer 822a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 822a. Each connection between a node and a receptive field for that node learns a weight and, in some cases, an overall bias such that each node learns to analyze its particular local receptive field in the input image. Each node of the hidden layer 822a will have the same weights and bias (called a shared weight and a shared bias). For example, the filter has an array of weights (numbers) and the same depth as the input. A filter will have a depth of 3 for the image or video frame example (according to three color components of the input image). An illustrative example size of the filter array is 5×5×3, corresponding to a size of the receptive field of a node.

The convolutional nature of the convolutional hidden layer 822a is due to each node of the convolutional layer being applied to its corresponding receptive field. For example, a filter of the convolutional hidden layer 822a can begin in the top-left corner of the input image array and can convolve around the input image. As noted above, each convolutional iteration of the filter can be considered a node or neuron of the convolutional hidden layer 822a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 822a. For example, a filter can be moved by a step amount to the next receptive field. The step amount can be set to 1 or another suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 822a.

The mapping from the input layer to the convolutional hidden layer 822a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 822a can include several activation maps in order to identify multiple features in an image. The example shown in FIG. 8 includes three activation maps. Using three activation maps, the convolutional hidden layer 822a can detect three different kinds of features, with each feature being detectable across the entire image.

In some examples, a non-linear hidden layer can be applied after the convolutional hidden layer 822a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 800 without affecting the receptive fields of the convolutional hidden layer 822a.

The pooling hidden layer 822b can be applied after the convolutional hidden layer 822a (and after the non-linear hidden layer when used). The pooling hidden layer 822b is used to simplify the information in the output from the convolutional hidden layer 822a. For example, the pooling hidden layer 822b can take each activation map output from the convolutional hidden layer 822a and generates a condensed activation map (or feature map) using a pooling function. Max-pooling is one example of a function performed by a pooling hidden layer. Other forms of pooling functions be used by the pooling hidden layer 822a, such as average pooling, L2-norm pooling, or other suitable pooling functions. A pooling function (e.g., a max-pooling filter, an L2-norm filter, or other suitable pooling filter) is applied to each activation map included in the convolutional hidden layer 822a. In the example shown in FIG. 8, three pooling filters are used for the three activation maps in the convolutional hidden layer 822a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 822a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 822a having a dimension of 24×24 nodes, the output from the pooling hidden layer 822b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 800.

The final layer of connections in the network is a fully-connected layer that connects every node from the pooling hidden layer 822b to every one of the output nodes in the output layer 824. Using the example above, the input layer includes 28×28 nodes encoding the pixel intensities of the input image, the convolutional hidden layer 822a includes 3×24×24 hidden feature nodes based on application of a 5×5 local receptive field (for the filters) to three activation maps, and the pooling layer 822b includes a layer of 3×12×12 hidden feature nodes based on application of max-pooling filter to 2×2 regions across each of the three feature maps. Extending this example, the output layer 824 can include ten output nodes. In such an example, every node of the 3×12×12 pooling hidden layer 822b is connected to every node of the output layer 824.

The fully connected layer 822c can obtain the output of the previous pooling layer 822b (which should represent the activation maps of high-level features) and determines the features that most correlate to a particular class. For example, the fully connected layer 822c layer can determine the high-level features that most strongly correlate to a particular class and can include weights (nodes) for the high-level features. A product can be computed between the weights of the fully connected layer 822c and the pooling hidden layer 822b to obtain probabilities for the different classes. For example, if the CNN 800 is being used to predict that an object in an image or video frame is a vehicle, high values will be present in the activation maps that represent high-level features of vehicles (e.g., two or four tires, a windshield, side view mirrors, etc.).

In some examples, the output from the output layer 824 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.9 0 0 0 0], the vector indicates that there is a 5% probability that the image is the third class of object (e.g., a person), an 80% probability that the image is the fourth class of object (e.g., a static object on a road or other driving surface), and a 9% probability that the image is the sixth class of object (e.g., a vehicle). The probability for a class can be considered a confidence level that the object is part of that class.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, an engine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for data processing, the apparatus comprising: at least one memory; and at least one processor coupled to the at least one memory and configured to: determine, based on characteristics of weights from a first matrix representation of a set of weights of a machine learning model, sensitivity levels of the weights; adjust an order of the first matrix representation to sort a subset of weights from the set of weights based on the sensitivity levels of the weights; process a portion of the first matrix representation associated with the subset of weights to adjust one or more weights from the subset of weights; and update the first matrix representation with the adjusted one or more weights from the subset of weights.

Aspect 2. The apparatus of Aspect 1, wherein the at least one processor is configured to: quantize the updated first matrix representation to generate a first quantized matrix representation of the set of weights.

Aspect 3. The apparatus of any of Aspects 1 to 2, wherein the at least one processor is configured to: process the first quantized matrix representation and a second quantized matrix representation of a set of tensors corresponding to the machine learning model to generate a second matrix representation of a set of activations of the machine learning model.

Aspect 4. The apparatus of Aspect 3, wherein the set of tensors of the second quantized matrix representation correspond to a linear layer of the machine learning model associated with one or more weights from the set of weights.

Aspect 5. The apparatus of any of Aspects 1 to 4, wherein the subset of weights includes one or more weights associated with a highest sensitivity level of determined sensitivity levels and one or more weights associated with a lowest sensitivity level of the determined sensitivity levels.

Aspect 6. The apparatus of any of Aspects 1 to 5, wherein the characteristics of the weights includes a magnitude of the weights, Hessian metrics of the first matrix representation, and a gradient of the weights.

Aspect 7. The apparatus of any of Aspects 1 to 6, wherein to process the portion of the first matrix representation to adjust the one or more weights from the subset of weights, the at least one processor is configured to: process the portion of the first matrix representation by performing a dot product of the subset of weights and a rotation matrix.

Aspect 8. The apparatus of Aspect 7, wherein the rotation matrix includes at least one of a Hadamard rotation matrix, a learned rotation matrix, or a Kronecker-decomposed matrix.

Aspect 9. The apparatus of any of Aspects 1 to 8, wherein to process the portion of the first matrix representation to adjust the one or more weights from the subset of weights, the at least one processor is configured to: process the portion of the first matrix representation by performing a dot product of the subset of weights and a per-channel scaling matrix.

Aspect 10. The apparatus of any of Aspects 1 to 9, wherein the per-channel scaling matrix includes at least one of a derived per-channel scaling matrix, a searched per-channel scaling matrix, or a learned per-channel scaling matrix.

Aspect 11. A method for data processing, comprising: determining, based on characteristics of weights from a first matrix representation of a set of weights of a machine learning model, sensitivity levels of the weights; adjusting an order of the first matrix representation to sort a subset of weights from the set of weights based on the sensitivity levels of the weights; processing a portion of the first matrix representation associated with the subset of weights to adjust one or more weights from the subset of weights; and updating the first matrix representation with the adjusted one or more weights from the subset of weights.

Aspect 12. The method of Aspect 11, further comprising: quantizing the updated first matrix representation to generate a first quantized matrix representation of the set of weights.

Aspect 13. The method of any of Aspects 11 to 12, further comprising: processing the first quantized matrix representation and a second quantized matrix representation of a set of tensors corresponding to the machine learning model to generate a second matrix representation of a set of activations of the machine learning model.

Aspect 14. The method of any of Aspects 11 to 13, wherein the set of tensors of the second quantized matrix representation correspond to a linear layer of the machine learning model associated with one or more weights from the set of weights.

Aspect 15. The method of any of Aspects 11 to 14, wherein the subset of weights includes one or more weights associated with a highest sensitivity level of determined sensitivity levels and one or more weights associated with a lowest sensitivity level of the determined sensitivity levels.

Aspect 16. The method of any of Aspects 11 to 15, wherein the characteristics of the weights includes a magnitude of the weights, Hessian metrics of the first matrix representation, and a gradient of the weights.

Aspect 17. The method of any of Aspects 11 to 16, further comprising: processing the portion of the first matrix representation by performing a dot product of the subset of weights and a rotation matrix.

Aspect 18. The method of Aspect 17, wherein the rotation matrix includes at least one of a Hadamard rotation matrix, a learned rotation matrix, or a Kronecker-decomposed matrix.

Aspect 19. The method of any of Aspects 11 to 18, further comprising: processing the portion of the first matrix representation by performing a dot product of the subset of weights and a per-channel scaling matrix.

Aspect 20. The apparatus of any of Aspects 11 to 19, wherein the per-channel scaling matrix includes at least one of a derived per-channel scaling matrix, a searched per-channel scaling matrix, or a learned per-channel scaling matrix.

Aspect 21. A non-transitory computer-readable medium having stored thereon instructions that, when executed by at least one processor, cause the at least one processor to perform one or more of operations according to any of Aspects 11 to 20.

Aspect 22. An apparatus for data processing comprising one or more means for performing operations according to any of Aspects 11 to 21.

What is claimed is:

1. An apparatus for data processing, the apparatus comprising:
at least one memory; and
at least one processor coupled to the at least one memory and configured to:
determine, based on characteristics of weights from a first matrix representation of a set of weights of a machine learning model, sensitivity levels of the weights;
adjust an order of the first matrix representation to sort a subset of weights from the set of weights based on the sensitivity levels of the weights;
process a portion of the first matrix representation associated with the subset of weights to adjust one or more weights from the subset of weights; and
update the first matrix representation with the adjusted one or more weights from the subset of weights.

2. The apparatus of claim 1, wherein the at least one processor is configured to:
quantize the updated first matrix representation to generate a first quantized matrix representation of the set of weights.

3. The apparatus of claim 2, wherein the at least one processor is configured to:
process the first quantized matrix representation and a second quantized matrix representation of a set of tensors corresponding to the machine learning model to generate a second matrix representation of a set of activations of the machine learning model.

4. The apparatus of claim 3, wherein the set of tensors of the second quantized matrix representation correspond to a linear layer of the machine learning model associated with one or more weights from the set of weights.

5. The apparatus of claim 1, wherein the subset of weights includes one or more weights associated with a highest sensitivity level of determined sensitivity levels and one or more weights associated with a lowest sensitivity level of the determined sensitivity levels.

6. The apparatus of claim 1, wherein the characteristics of the weights includes a magnitude of the weights, Hessian metrics of the first matrix representation, and a gradient of the weights.

7. The apparatus of claim 1, wherein to process the portion of the first matrix representation to adjust the one or more weights from the subset of weights, the at least one processor is configured to:
process the portion of the first matrix representation by performing a dot product of the subset of weights and a rotation matrix.

8. The apparatus of claim 7, wherein the rotation matrix includes at least one of a Hadamard rotation matrix, a learned rotation matrix, or a Kronecker-decomposed matrix.

9. The apparatus of claim 1, wherein to process the portion of the first matrix representation to adjust the one or more weights from the subset of weights, the at least one processor is configured to:
process the portion of the first matrix representation by performing a dot product of the subset of weights and a per-channel scaling matrix.

10. The apparatus of claim 9, wherein the per-channel scaling matrix includes at least one of a derived per-channel scaling matrix, a searched per-channel scaling matrix, or a learned per-channel scaling matrix.

11. A method for data processing, comprising:
determining, based on characteristics of weights from a first matrix representation of a set of weights of a machine learning model, sensitivity levels of the weights;
adjusting an order of the first matrix representation to sort a subset of weights from the set of weights based on the sensitivity levels of the weights;
processing a portion of the first matrix representation associated with the subset of weights to adjust one or more weights from the subset of weights; and
updating the first matrix representation with the adjusted one or more weights from the subset of weights.

12. The method of claim 11, further comprising:
quantizing the updated first matrix representation to generate a first quantized matrix representation of the set of weights.

13. The method of claim 12, further comprising:
processing the first quantized matrix representation and a second quantized matrix representation of a set of tensors corresponding to the machine learning model to generate a second matrix representation of a set of activations of the machine learning model.

14. The method of claim 13, wherein the set of tensors of the second quantized matrix representation correspond to a linear layer of the machine learning model associated with one or more weights from the set of weights.

15. The method of claim 11, wherein the subset of weights includes one or more weights associated with a highest sensitivity level of determined sensitivity levels and one or more weights associated with a lowest sensitivity level of the determined sensitivity levels.

16. The method of claim 11, wherein the characteristics of the weights includes a magnitude of the weights, Hessian metrics of the first matrix representation, and a gradient of the weights.

17. The method of claim 11, further comprising:
processing the portion of the first matrix representation by performing a dot product of the subset of weights and a rotation matrix.

18. The method of claim 17, wherein the rotation matrix includes at least one of a Hadamard rotation matrix, a learned rotation matrix, or a Kronecker-decomposed matrix.

19. The method of claim 11, further comprising:
processing the portion of the first matrix representation by performing a dot product of the subset of weights and a per-channel scaling matrix.

20. A non-transitory computer-readable medium having stored thereon instructions that, when executed by at least one processor, cause the at least one processor to:
determine, based on characteristics of weights from a first matrix representation of a set of weights of a machine learning model, sensitivity levels of the weights;
adjust an order of the first matrix representation to sort a subset of weights from the set of weights based on the sensitivity levels of the weights;
process a portion of the first matrix representation associated with the subset of weights to adjust one or more weights from the subset of weights; and
update the first matrix representation with the adjusted one or more weights from the subset of weights.
